(19) United States
(12) Patent Application Publication
(10) Pub. No.: US 2006/0093743 A1
(43) Pub. Date: May 4, 2006

(54) Wood preservation method

(75) Inventor: Thomas E. Lippincott, Rocky Point, NC (US)

Correspondence Address: WILLIAM J. MASON;MACCORD MASON PLLC, POST OFFICE BOX 1489, WRIGHTSVILLE BEACH, NC, 28480, US

(73) Assignee: Tank Fab Inc.

(21) Appl. No.: 10/975,635

(22) Filed: Oct. 28, 2004

(51) Int. Cl. B05D 3/12

(52) U.S. Cl. 427/351

(57) ABSTRACT

Wood is pressure treated in a pressure autoclave by drawing an initial vacuum in the autoclave to remove air from the autoclave and the wood; filling the autoclave with inert gas while the autoclave is under vacuum; filling the chamber with a preservative comprised of a silane compound, a liquid hydrocarbon solvent, and optional pesticides; pressurizing the autoclave to impregnate the wood with the preservative; draining the preservative from the autoclave; and applying a final vacuum to the autoclave to remove excess solvent from the autoclave and the wood.

### BACKGROUND OF THE INVENTION

(1) Field of the Invention

This invention relates to a method of pressure treating wood with a composition comprised of a silane compound and a liquid hydrocarbon solvent, preferably also including one or more pesticides.

(2) Description of the Prior Art

Wood and wood-derived products are treated with preservatives to prevent decay. Two pressure treatment processes are conventionally used to effect the needed penetration of the treatment chemicals into the cellular structure of the wood, thereby providing sufficient chemical for preservation, and reducing leaching of the chemical from the wood. These processes are commonly known as full-cell and empty-cell processes. In the full-cell process, both the cell wall and lumen are filled with preservative, while only the cell wall is filled in the empty-cell process. In both processes, the wood to be treated is placed in a high pressure autoclave or retort, which may be 6 to 9 feet in diameter and up to 150 feet in length. These autoclaves are built to withstand pressure of up to 500 psi.

The full-cell process is normally used when a large amount of preservative is required, such as in the treatment of utility poles, farm fences, and bridge and pier timbers. In the full-cell process, the wood is sealed in the autoclave and a vacuum of from about 22 to about 30 inches Hg is applied for from about 30 seconds to about 1 hour. The autoclave is then filled with the preservative without breaking the vacuum and the pressure is increased to from about 75 psig to about 250 psig. After no more preservative will enter the wood, the pressure is released and the autoclave is emptied of preservative. Then a final vacuum of from about 23 inches to about 30 inches Hg is applied to remove excess preservative. This vacuum is held anywhere from 1 minutes to 3 hours. The wood is then removed from the autoclave.

The empty-cell process is used to obtain deep preservative penetration with a relatively low net preservative retention level. In the empty-cell treatment process, the wood in the autoclave is initially pressured to from about 1 to about 100 psi. The treating autoclave is then filled with preservative, and the pressure is increased to a range of 75 psig to 250 psig to force the preservative into the wood. After the preservative has penetrated into the wood, the preservative is removed from the autoclave and a final vacuum is applied to remove excess preservative.

Conventional wood preservatives fall into three broad categories: creosote and creosote solutions, oilborne preservatives, and waterborne preservatives. Creosote is used as a preservative for railroad ties, large timbers, poles, and pilings. Creosote is oily, toxic and tends to bleed from the wood. Oilborne preservatives, e.g., pentachlorophenol (penta), are also used to treat poles, fence posts, etc., and are commonly dissolved in petroleum or other organic solvents. Wood treated with creosote and oilborne preservatives have an oily surface and are unpaintable. Waterborne preservatives, including various metallic salts, are dissolved in water and have the advantages of low toxicity and resultant products that are paintable. Typical chemicals are chromated copper arsenate, ammoniacal copper zinc arsenate, and almine copper quat.

U.S. patent application Ser. No. 10/297,398, to Thompson, based on PCT No. PCT/US01/18280, filed Jun. 6, 2001, and published as Pub. No. 2003/0213400, on Nov. 20, 2003, describes wood preservation compositions comprised of at least one boron compound and at least one silane compound. The preservatives also include a solvent, such as tetrahydrofuran, or a hydrocarbon that is liquid at room temperature, e.g., pentane, hexane, or heptane. Examples in the Thompson application describe the application of these compositions to wood by spraying or dipping.

This surface treatment is useful in demonstrating the preservative attributes of the Thompson compositions. However, in order to achieve the desired level of wood preservation in commercial applications, and to prevent seepage of the preservatives from the wood, penetration of the wood by the preservatives is required. Conventional full-cell and empty-cell wood treatment methods as described above are not suitable for this purpose due to the high volatility of the solvents proposed, and the danger that the solvents will burn or explode during the process. The silane compounds may also be combustible. Therefore, there is a need for an effective and safe method of penetrating wood with preservative compositions of the type proposed by Thompson.

### SUMMARY OF THE INVENTION

The present invention is directed to a method for preserving wood products by pressure treating the wood products in an enclosed vessel with a preservative composition comprised of a silane compound and a liquid hydrocarbon solvent preferably also including one or more pesticides. As used herein, the terms “wood” and “wood products” includes timber and dimensioned wood products such as plywood, OSB, lumber, posts, poles, pilings, etc., and wood-derived products, such as paper, dry wall, cardboard, etc.

Generally, the method of the present invention comprised providing a pressure treating autoclave sized to hold the wood products to be treated; sealing the wood in the autoclave; drawing an initial vacuum in the autoclave to remove air from the autoclave and the wood; filling the autoclave with inert gas while the autoclave is under vacuum; filling the chamber with a preservative composition comprised of a silane compound dissolved in a liquid hydrocarbon solvent; pressurizing the autoclave; draining the preservative from the autoclave; and applying a final vacuum to the autoclave to remove excess solvent. In the preferred embodiment, the preservative composition also includes one or more pesticides, e.g., a boron compound, an organophosphate, or a synthetic pyrethroid.

More specifically, an initial vacuum from about 1 inch to about 30 inches of Hg is drawn on the autoclave to remove air from the autoclave and wood; the autoclave is filled with an inert gas, which will raise the autoclave pressure to a range of 0 psig to 100 psig; the autoclave is then filled with the preservative; the autoclave's pressure is then raised to a pressure range from 0 psig to 500 psig to force the preservative into the wood; the autoclave is drained of preservative; then a final vacuum of from about 1 inch to 30 inches of Hg is drawn inside the autoclave to remove excess solvent from the autoclave and the wood. Normally, the initial vacuum used to remove the air from the autoclave and the wood will be maintained for up to about 1 minute before the introduction of the inert gas blanket, and the total time the autoclave will be pressurized is from about 1 minute to 6 hours.

Silane compounds, also referred to as silane or silanes, are generally defined as a class of silicon-based materials, analogous to alkanes, that is, straight-chain, saturated paraffin hydrocarbons having the general formula SiₙH₂ₙ₊₂, wherein n is an integer equal to 1 or higher. The silanes used in the present invention are halosilanes, i.e., silanes containing at least one halogen. Preferably, the halogen is chlorine. A particularly suitable halosilane is trichloromethylsilane (chemical formula: CH₃Cl₃Si), although other silanes are acceptable. Examples of other silanes useful in practicing the present invention include, without limitation:

(Chloromethyl) Trichlorosilane; [3-(Heptafluoroisoproxy)Propyl]Trichlorosilane; 1,6-Bis(Trichlorosilyl)Hexane; 3-Bromopropyltrichlorosilane; Allylbromodimethylsilane; Allyltrichlorosilane; Bromomethylchlorodimethylsilane; Bromothimethylsilane; Chloro(Chloromethyl)Dimethylsilane; Chlorodiisopropyloctylsilane; Chlorodiisopropylsilane; Chlorodimethylethylsilane; Chlorodimethylphenylsilane; Chlorodimethylsilane; Chlorodiphenylmethylsilane; Chlorotriethylsilane; Chlorotrimethylsilane; Dichlorodimethylsilane; Dichloromethylsilane; Dichloromethylvinylsilane; Diphenyldichlorosilane; Di-t-Butylchlorosilane; Ethyltrichlorosilane; Iodotrimethylsilane; Pentyltrichlorosilane; Phenyltrichlorosilane; Trichloro(3,3,3-Trifluoropropyl)Silane; Trichloro(Dichloromethyl)Silane; and Trichlorovinylsilane.

The preservative solvent is a liquid hydrocarbon selected from the group consisting of pentane, hexane, heptane, octane, tetrahydrofuran, furan, and mixtures thereof. It is understood that “liquid” means liquid at room temperature.

Preferably, the preservative composition also includes a pesticide, e.g., an organic fungicide, insecticide, termiticide, or bacteriocide. Preferred pesticides include boron compounds, organophosphates, synthetic pyrethroids, and combinations thereof. Combination of the silane compound and the pesticide in the solvent results in a synergistic result in that the silane compound “locks” the pesticide into the wood, preventing leaching of the pesticide.

Preferred boron compounds used in the preservative composition are boric acid (chemical formula: B(OH)₃) and boric anhydride (chemical formula: B₂O₃), although other forms of boron-containing materials are acceptable, e.g., borax (chemical formula: Na₂B₄O₇.10H₂O), and disodium octaborate tetrahydrate (chemical formula: Na₂B₈O₁₃.4H₂O).

Organophosphates include chlorpyrifos, such as sold under the trademark Dursban. Synthetic pyrethroids include Permethrin, Cyflutrin, Cypermethrin, Bifenthrin and Deltamethrin.

Synthetic pyrethroids may, for example, be dissolved in a suitable solvent in the following amounts:

| Insecticide | Density | lbs./gal | % Active | lbs/200′ Solvent |
|---|---|---|---|---|
| Permethrin | 1.2 | 9.6 | 0.28 | 3.64 |
| Cyflutrin | 1.346 | 10.768 | 0.25 | 4.08 |
| Cypermethrin | 1.25 | 10 | 0.26 | 3.92 |
| Bifenthrin | 1.017 | 8.136 | 0.251 | 4.06 |
| Deltamethrin | 0.5 | 4 | 0.98 | 1.04 |

Additional pesticides include carboxylic acids such as naphthenic acids and branched aliphatic acids and their metal salts such as copper and zinc naphthenate, phenols and substituted phenols such as orthophenyl phenol and its alkali metal or ammonia salts; polyhalogenated phenols such as pentachlorophenol or tribromophenol and their alkali metal or ammonia salts; quaternary ammonium salts and tertiary amine salts such as didecyl dimethyl ammonium chloride, octyl decyl dimethyl ammonium chloride, dodecyl dimethyl benzyl ammonium chloride, dodecyl benzyl trimethyl ammonium chloride, dodecyl dimethyl amine acetate, dodecyl dimethyl amine lactate, dodecyl dimethyl amine salicylate, didodecyl methyl amine chloride; isothiazolone derivatives such as 4,5-dichloro-2-(n-octyl)-4-isothiazolin-3-one or 2-methyl-4-isothiazolin-3-one, 2n-octyl-4-isothiazolin-3-one and mixtures of those and other related compounds; sulphamide derivatives such as N,N-dimethyl-N-phenyl-(N-fluorodichloro-methylthio)-sulphonamide, N,N-dimethyl-N-tolyl-N-(dichlorofluoro-methylthio)-sulphamide; azoles such as imidazole; MBT (methylene-bis thiocyanate); IPBC (3-iodo-2-propanyl-butyl-carbamate); carbendazim and chlorothalonil; N-nitrosophenylhydroxylamine and N-nitroso cyclohexyl hydroxylamine, either as their metal salts or as metal chelates; pyrethroid type insecticides selected from the group consisting of cyano-(4-fluoro-3-phenoxyphenyl)-methyl-3-(2,2-dichloroethenyl)-2,2-dimeth yl-cyclopropanecarboxylate, (3-phenoxyphenyl)-methyl-3-(2,2-dichloroethyenyl)-2,2-dimethylcyclopropane carboxylate, cyano-(3-phenoxyphenyl)-methyl-2-(4-chlorophenyl)-3-methylbutyrate, and mixtures thereof, organo-phosphorous, carbamate and organochlorine insecticides such as lindane.

The preservative compositions used in the present invention are comprised of from about 0.5% to about 10%, and preferably from about 1% to about 5% percent by weight silane compound, with the remainder of the composition being solvent and any optional ingredients. Pesticides, if used in the composition, will normally be used in an amount of from about 0.1% to about 10%, and preferably from about 2% to about 6%, percent by weight of the composition.

### DETAILED DESCRIPTION OF THE INVENTION

The following examples exemplify the practice of the present invention:

### EXAMPLE 1

### Treatment of Paper

A roll of paper was loaded into the treating autoclave and sealed. A vacuum of 25″ Hg was pulled inside of the autoclave and held for a period of 5 seconds. The autoclave was then filled with nitrogen until a pressure of 1 psig was achieved inside of the autoclave. The autoclave was then filled with a preservative composition comprised of Silane and a pentane solvent. As the autoclave was filling with preservative, the nitrogen was compressed, resulting in a pressure of about 30 psig. Once the autoclave was full of preservative, additional pressure and preservative was pushed into the autoclave so that the preservative was pressed into the paper. The autoclave was then drained of the preservative once a pressure of 300 psig was achieved with approx. 2.3 gal. of preservative per cu. ft. pressed into the paper. A final vacuum of 25″ of Hg was then applied inside of the autoclave to pull the pentane solvent out of the paper, with the vacuum being held for a period of 1 minute. The vacuum was then released from inside of the autoclave and the autoclave door was opened and the roll of treated paper was removed.

### EXAMPLE 2

### Treatment of Dimensional Wood

Dimensional wood was loaded into the treating autoclave, and the autoclave door was closed. A vacuum of 25″ Hg was applied and held for 5 seconds. The autoclave was then filled with nitrogen until a pressure of 1 psig was achieved inside of the autoclave. The autoclave was then filled with the preservative comprised of Silane, a boron type insecticide, and a pentane solvent. As the autoclave was filling with preservative, the nitrogen was being vented so that the pressure of 1 psig was maintained inside of the autoclave. Once the autoclave was full of preservative, the vent valve that was opened to vent the nitrogen was closed. Additional pressure and preservative was pushed into the autoclave so that the preservative was pressed into the wood. Once a pressure of 100 psig was achieved, which was approx. 2.3 gal. of preservative per cu. ft. of wood, the autoclave was then drained of the preservative. As the preservative was drained from the wood, a blanket of nitrogen was again placed inside of the autoclave. After the preservative was drained from the autoclave, a final vacuum of 25″ of Hg was applied inside of the autoclave and held for 1 minute to pull the pentane solvent out of the wood. After 1 minute the vacuum was released from inside of the autoclave and autoclave door was opened to remove the treated dimensional wood.

Certain modifications and improvements will occur to those skilled in the art upon a reading of the foregoing description. It should be understood that all such modifications and improvements have been deleted herein for the sake of conciseness and readability but are properly within the scope of the following claims.

What is claimed is:

1. A method of pressure treating wood in a pressure autoclave comprising:
a) drawing an initial vacuum to remove air from the autoclave and the wood;
b) filling the autoclave with inert gas while the autoclave is under vacuum;
c) filling the chamber with a preservative comprised of a silane and a liquid hydrocarbon solvent;
d) pressurizing the autoclave to impregnate the wood with the preservative; and
e) applying a final vacuum to the autoclave to remove excess solvent.

2. The method of claim 1, wherein said preservative also includes a pesticide.

3. The method of claim 1, wherein said inert gas is nitrogen.

4. The method of claim 1, wherein the initial vacuum is from about 1 to about 30 inches of Hg.

5. The method of claim 1, wherein the autoclave is pressurized to from about 0 psig to about 500 psig.

6. The method of claim 1, wherein the final vacuum is from about 1 to about 30 inches of Hg.

7. The method of claim 1, wherein the silane compound is a halosilane.

8. The method of claim 1, wherein the solvent is selected from the group consisting of pentane, hexane, heptane, octane, tetrahydrofuran, furan, and mixtures thereof.

9. The method of claim 1, wherein the preservative includes from about 1 to about 5 percent by weight silane.

10. A method of pressure treating wood in a pressure autoclave comprising:
a) drawing an initial vacuum in the autoclave to remove air from the autoclave and the wood;
b) filling the autoclave with inert gas while the autoclave is under vacuum;
c) filling the chamber with a preservative comprised of a halosilane and a liquid hydrocarbon solvent selected from the group consisting of pentane, hexane, heptane, octane, and mixtures thereof;
d) pressurizing the autoclave to impregnate the wood with the preservative;
e) draining the preservative from the autoclave; and
f) applying a final vacuum to the autoclave to remove excess solvent from the autoclave and the wood.

11. The method of claim 10, wherein said preservative compound also includes a pesticide selected from the group consisting of boron compounds, organophosphates, synthetic pyrethroids, and mixtures thereof.

12. The method of claim 10, wherein said inert gas is nitrogen.

13. The method of claim 10, wherein the initial vacuum is from about 1 to about 30 inches of Hg.

14. The method of claim 10, wherein the autoclave is pressurized to from about 0 psig to about 500 psig.

15. The method of claim 10, wherein the final vacuum is from about 1 to about 30 inches of Hg.

16. The method of claim 10, wherein the boron compound is selected from the group consisting of a boric acid and boric anhydride.

17. The method of claim 10, wherein the silane compound is a halosilane.

18. The method of claim 10, wherein the solvent is selected from the group consisting of pentane, hexane, heptane, octane, tetrahydrofuran, furan, and mixtures thereof.

19. The method of claim 10, wherein the preservative includes from about 1 to about 5 percent by weight silane compound.

20. A method of pressure treating wood in a pressure autoclave comprising:
a) drawing an initial vacuum of from about 1 to about 30 inches of Hg in the autoclave to remove air from the autoclave and the wood;
b) filling the autoclave with nitrogen while the autoclave is under vacuum;
c) filling the chamber with a preservative comprised of from about 0.5 to about 10 percent by weight of silane, from about 0.1 to about 10 percent by weight of a pesticide, and a liquid hydrocarbon solvent selected from the group consisting of pentane, hexane, heptane, octane, tetrahydrofuran, furan and mixtures thereof;
d) pressurizing the autoclave to from about 0 psig to about 500 psig to impregnate the wood with the preservative;
e) draining the preservative from the autoclave; and
f) applying a final vacuum of from about 1 to about 30 inches of Hg to the autoclave to remove excess solvent form the autoclave and the wood.

21. The method of claim 20, wherein said pesticide is selected from the group consisting of boron compounds, organophosphates, synthetic pyrethroids, and mixtures thereof.

22. The method of claim 20, wherein said silane is trichloromethylsilane.

23. The method of claim 20, wherein said silane is from about 1 to about 5 percent by weight of said preservative.
